(19) United States
(12) Patent Application Publication
(10) Pub. No.: US 2011/0007068 A1
(43) Pub. Date: Jan. 13, 2011

(54) DISPLAY PANEL DRIVER, DISPLAY APPARATUS, AND DISPLAY PANEL DRIVING METHOD

(75) Inventor: Tamotsu Okutani, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: RENESAS ELECTRONICS CORPORATION, Kawasaki (JP)

(21) Appl. No.: 12/825,958

(22) Filed: Jun. 29, 2010

(30) Foreign Application Priority Data
Jul. 8, 2009 (JP) 2009-162132

(51) Int. Cl. G09G 5/00

(52) U.S. Cl. 345/214

(57) ABSTRACT

A display panel driver includes: a latch block configured to latch a drive data signal corresponding to an image in response to assertion of a latch enable signal supplied externally and output the latched drive data signal as a first latch data signal; an output control block configured to delay the first latch data signal in response to the latch enable signal to generate a second latch data signal; and a drive circuit section configured to drive a wiring provided in a display panel in response to the second latch data signal. One of rising timing and falling timing of the second latch data signal outputted from the output control block is delayed from the other timing. The one timing is determined in response to negation of the latch enable signal, and the other timing is determined regardless of the negation of the latch enable signal.

### INCORPORATION BY REFERENCE

This patent application claims a priority on convention based on Japanese Patent Application No. 2009-162,132 filed on Jul. 8, 2009. The disclosure thereof is incorporated herein by reference.

### TECHNICAL FIELD

The present invention relates to a display panel driving device, a display apparatus, and a display panel driving method, and more particularly, to a driving technique for driving a wiring line serving as a capacitive load, such as a data electrode wiring line provided in an AC driven plasma display panel (PDP) or an electroluminescence (EL) panel.

### BACKGROUND ART

A display panel used for a plasma television or the like is rapidly increase in size in recent years, and even a PDP having as a large size as 100 inches is developed. Also, along with the increase in panel size, various problems occur.

One of the problems associated with the increase in display panel size is an increase in power consumption. When the size of a display panel increases, lengths of wiring lines provided in the display panel increase, so that an electrostatic capacitance between adjacent wiring lines increases. For example, in a plasma display panel, a data electrode wiring line increases, and thereby electrostatic capacitances between the data electrode wiring line and a scan electrode wiring line, and between the data electrode wiring line and a holding electrode wiring line increase. When the electrostatic capacitances between the wiring lines increase, a large amount of charges are required to drive the wiring lines, so that a power consumption amount necessary to drive the wiring lines increases.

In such a situation, a technique to reduce the power consumption amount is investigated. For example, patent literature 1 discloses a technique for reducing a power consumption amount due to charge/discharge of an electrostatic capacitor between adjacent data electrode wiring lines (in the patent literature 1, address electrode wirings). The patent literature 1 discloses the technique that when one of two adjacent data electrode wiring lines rises, and the other one falls, rising timing and falling timing are made different from each other to thereby reduce the power consumption amount. FIG. 1 shows timing charts in an example of such an operation. In the example of FIG. 1, the rising timing of a data electrode wiring line Wₖ is delayed later from falling timing of a data electrode wiring line Wₖ₊₁. Under the condition that an electrostatic capacitance between the data electrode wiring lines Wₖ and Wₖ₊₁ is C_{w}, a low level is 0 (V), and a high level is V_{w} (V), if the rising timing of the data electrode wiring line Wₖ and the falling timing of the data electrode wiring line Wₖ₊₁ are simultaneous, a power consumption amount necessary to drive the data electrode wiring lines Wₖ and Wₖ₊₁ is 2×C_{w}·V_{w}². On the other hand, if the rising timing and the falling timing are made different from each other, the power consumption amount necessary to drive the data wiring lines Wₖ and Wₖ₊₁ can be reduced to C_{w}·V_{w}².

In order to differentiate the rising timing and the falling timing from each other, a circuit configuration of a data driver should be devised. The above-described patent literature 1 discloses an example of a configuration of the data driver that differentiates the rising timing and the falling timing from each other. FIG. 2 is a block diagram illustrating the configuration of the data driver disclosed in the patent literature 1.

When drive data DATAIN is outputted from a controller as serial data, the drive data DATAIN are sequentially supplied to a shift register 124 and converted to parallel drive data S₁ to Sₘ. The parallel drive data S₁ to Sₘ are outputted to latch circuits 125. When latch enable signals LE₁ to LEₘ supplied to latch enable terminals are asserted (e.g., set to a high level), the latch circuits 125 latch the parallel drive data S₁ to Sₘ from the shift register 124 in response to the assertion, and the latched parallel drive data S₁ to Sₘ are outputted as latch data L₁ to Lₘ, respectively.

In the data driver of FIG. 2, rising timing and falling timing of an address pulse applied to a data electrode wiring line are controlled by two external control signals. Specifically, pulse control circuits 123 are provided to supply the latch enable signals LE₁ to LEₘ to the latch circuits 125, and each of the pulse control circuits 123 is controlled by a rise latch enable signal LE and fall latch enable signal /LE. Each of the pulse control circuits 123 includes two AND circuits 123a and 123b and an OR circuit 123c. According to a circuit configuration of the pulse control circuits 123 illustrated in FIG. 2, if the parallel drive data Si is “0” (i.e., at a low level), timing at which latch enable signal LEi rises is controlled in response to the rise latch enable signal LE, whereas if the parallel drive data Si is “1” (i.e., at the high level), timing at which the latch enable signal LEi falls is controlled in response to the fall latch enable signal /LE. When the latch enable signals LE₁ to LEₘ are asserted, the latch circuits 125 latch the parallel drive data S₁ to Sₘ outputted from the shift register 124 and output them as the latch data L₁ to Lₘ.

The latch data L₁ to Lₘ outputted from the latch circuits 125 are respectively supplied to level shifters 126, FET drive buffers 127, and FET drive inverters 128. Field effect transistors (FETs) 129 and 130 constituting totem pole circuits are on/off controlled on the basis of output signals outputted from the FET drive buffers 127 and the FET drive inverters 128. In this way, voltages of Vw (V) or 0 (V) are outputted from output terminals O₁ to Oₘ of the totem pole circuits, respectively.

In the data driver having such a configuration, rising timings of output signals from the output terminals O₁ to Oₘ of the totem pole circuits are controlled by the rise latch enable signal LE, and falling timings are controlled by the fall latch enable signal /LE. For example, if the rising timing of the rise latch enable signal LE is delayed later from the fall latch enable signal /LE, the rising timings of output signals rising from 0 (V) to Vw (V) among the output signals outputted from the output terminals O₁ to Oₘ of the totem pole circuits are delayed later from the falling timings of output signals falling from Vw (V) to 0 (V). According to such an operation, the rising timing of the data electrode wiring line Wₖ is delayed later from the falling timing of the adjacent data electrode wiring line Wₖ₊₁, which reduces the power consumption amount.

### Citation List:

[patent literature 1]: JP-A-Heisei 10-187093

### SUMMARY OF THE INVENTION

One problem of the data driver in FIG. 2 is in that in order to externally control the pulse control circuits 123, two external control signals, i.e., the rise latch enable signal LE and the fall latch enable signal /LE, are required. This causes the number of input terminals (e.g., pads and leads) of the data driver to be increased, which is not preferable from the view of assembling.

In an aspect of the present invention, a display panel driver includes: a latch block configured to latch a drive data signal corresponding to an image in response to assertion of a latch enable signal supplied externally and output the latched drive data signal as a first latch data signal; an output control block configured to delay the first latch data signal in response to the latch enable signal to generate a second latch data signal; and a drive circuit section configured to drive a wiring provided in a display panel in response to the second latch data signal. One of rising timing and falling timing of the second latch data signal outputted from the output control block is delayed from the other timing. The one timing is determined in response to negation of the latch enable signal, and the other timing is determined regardless of the negation of the latch enable signal.

In another aspect of the present invention, a display apparatus includes: a display panel; a display panel driver configured to drive a wiring provided in the display panel; and a controller configured to supply a latch enable signal and a drive data signal corresponding to an image. The display panel driver includes: a latch block configured to latch the drive data signal in response to assertion of a latch enable signal and output the latched drive data signal as a first latch data signal; an output control block configured to delay the first latch data signal in response to the latch enable signal to generate a second latch data signal; and a drive circuit section configured to drive the wiring provided in the display panel in response to the second latch data signal. One of rising timing and falling timing of the second latch data signal outputted from the output control block is delayed from the other timing. The one timing is determined in response to negation of the latch enable signal, and the other timing is determined regardless of the negation of the latch enable signal.

In still another aspect of the present invention, a method of driving a display panel, is achieved by supplying a latch enable signal and a drive data signal corresponding to an image to a display panel driver; by latching the drive data signal in response to assertion of the latch enable signal; outputting the latched drive data signal as a first latch data signal; by delaying the first latch data signal in response to the latch enable signal to generate a second latch data signal; and by driving a wiring provided in a display panel in response to the second latch data signal. One of rising timing and falling timing of the second latch data signal outputted from the output control block is delayed from the other timing. The one timing is determined in response to negation of the latch enable signal, and the other timing is determined regardless of the negation of the latch enable signal.

According to the present invention, a drive operation in which rising timing and falling timing of a wiring line of a display panel are different from each other can be achieved with a small number of external control signals.

### BRIEF DESCRIPTION OF THE DRAWINGS

The above and other objects, advantages and features of the present invention will be more apparent from the following description of certain embodiments taken in conjunction with the accompanying drawings, in which:

FIG. 1 shows timing charts in a conventional driving method of data electrode wiring lines;

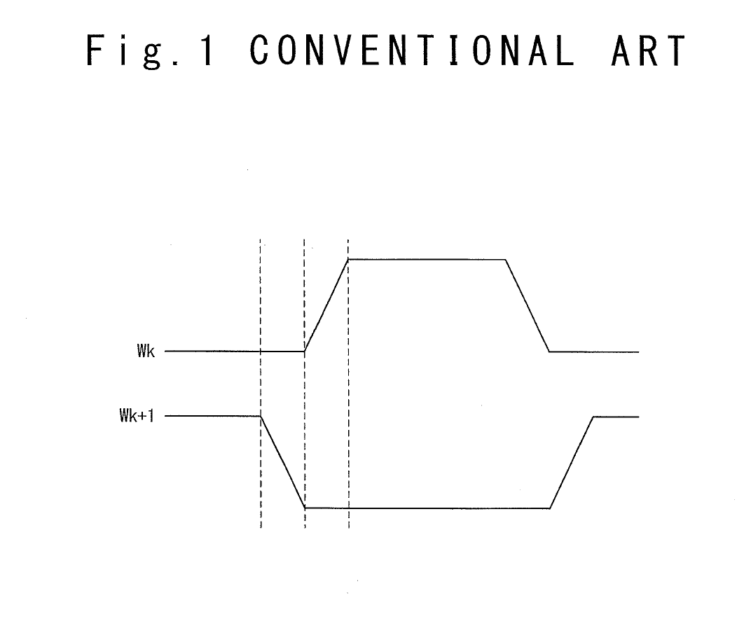

FIG. 2 is a block diagram illustrating a configuration of the conventional data driver;

FIG. 3 is a block diagram illustrating a configuration of a display apparatus according to one embodiment of the present invention;

FIG. 4 is a block diagram illustrating a configuration of a data driver in the embodiment of the present embodiment;

FIG. 5 is a circuit diagram illustrating a configuration of an output control block in the embodiment of the present invention;

FIG. 6 shows timing charts in an operation of the data driver in the embodiment of the present invention;

FIG. 7 shows timing charts in an operation of an output control block in the embodiment of the present invention;

FIG. 8 is a circuit diagram illustrating a configuration of an output control block in another embodiment of the present invention; and

FIG. 9 shows timing charts in an operation of the output control block in the other embodiment of the present invention.

### DESCRIPTION OF EMBODIMENTS

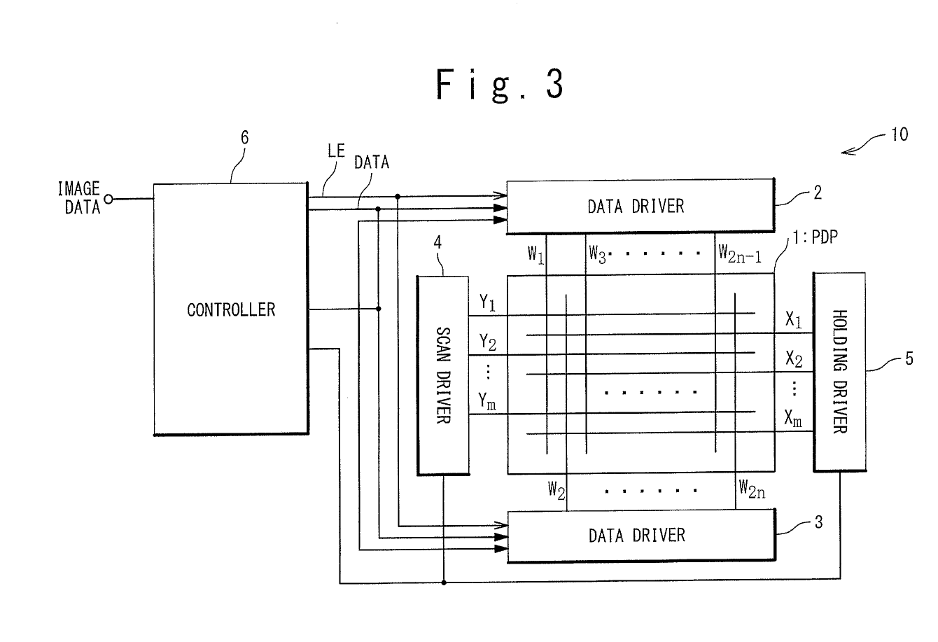

FIG. 3 is a block diagram illustrating a configuration of a display apparatus according to an embodiment of the present invention. The display apparatus 10 of FIG. 3 is configured as a plasma display apparatus. It should be noted that the present invention can also be applied to another display apparatus using a display panel having a wiring line serving as a capacitive load such as liquid crystal display panel or EL panel.

The display apparatus 10 is provided with a plasma display panel 1, data drivers 2 and 3, a scan driver 4, a holding driver 5, and a controller 6. The plasma display panel 1 is provided with data electrode wiring lines W₁ to W₂ₙ, scan electrode wiring lines Y₁ to Yₘ, and holding electrode wiring lines X₁ to Xₘ. The data drivers 2 and 3 drive the data electrode wiring lines W₁ to W₂ₙ in response to a drive data DATA received from the controller 6. In the present embodiment, the two data driver 2 and 3 are provided on an upper side and a lower side of the plasma display panel 1. One data driver 2 drives odd-numbered data electrode wiring lines W₁, W₃, . . . , W₂ₙ₋₁, whereas the other data driver 3 drives even-numbered data electrode wiring lines W₂, W₄, . . . , W₂ₙ. Also, the scan driver 4 drives the scan electrode wiring lines Y₁ to Yₘ, and the holding driver 5 drives the holding electrode wiring lines X₁ to Xₘ. The controller 6 generates the drive data DATA from externally supplied image data to supply as serial data to the data driver 2. The controller 6 further supplies a control signal to control the data drivers 2 and 3, the scan driver 4, and the holding driver 5. The control signal supplied to the data drivers 2 and 3 includes a latch enable signal LE. As will be described later, the latch enable signal LE is a signal to allow latch blocks included in the data drivers 2 and 3 to perform a latching operation.

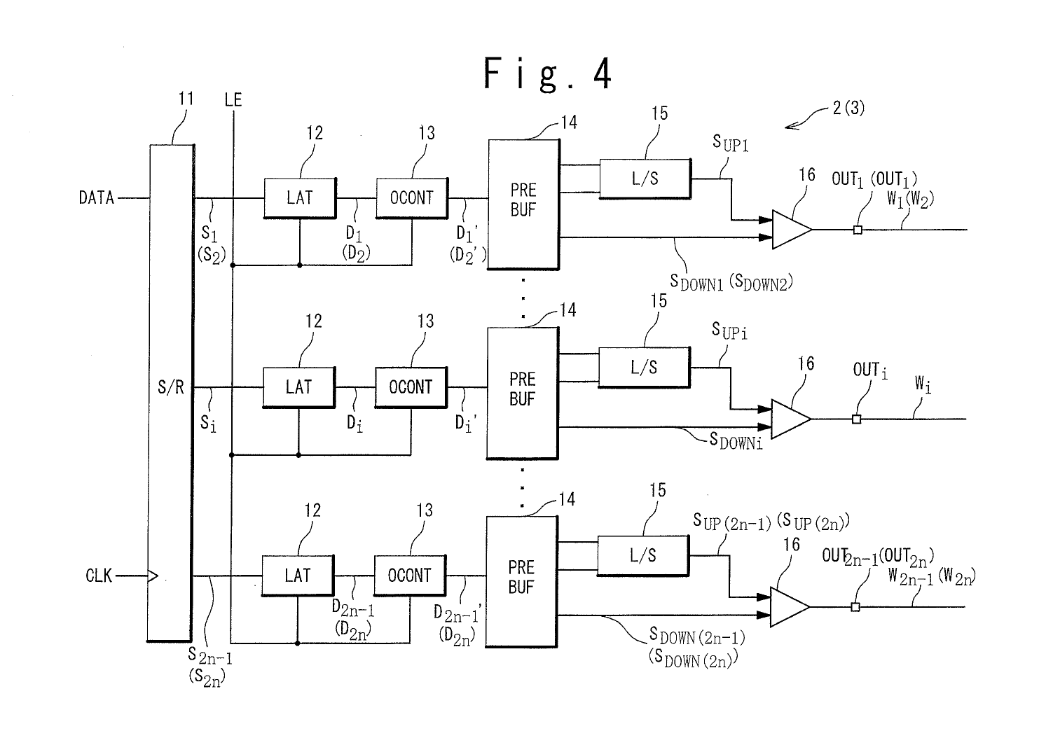

FIG. 4 is a block diagram illustrating a configuration of the data driver 2 in the present embodiment. The data driver 2 is provided with a shift register 11, latch blocks (LAT) 12, output control blocks (OCONT) 13, pre-buffers 14, level shifters (L/S) 15, and output buffers 16.

The shift register 11 performs serial-parallel conversion on the drive data DATA sequentially received from the controller 6 to generate drive data signals S₁, S₃, . . . , S₂ₙ₋₁ corresponding to the drive data DATA, and distributes them to the latch blocks 12.

Each of the latch blocks 12 latches the drive data signal Sᵢ in response to assertion of the latch enable signal LE, and supplies the latched drive data signal to the output control block 13. It should be noted that the drive data signal supplied to the output control block 13 from the latch block 12 corresponding to the data electrode wiring line Wᵢ is referred to as a latch data signal Dᵢ hereinafter. Also, in the following, a description will be given on the assumption that the latch enable signal LE is low active in the present embodiment. That is, a state that the latch enable signal LE is set to a Low level is referred to as a state that the latch enable signal LE is asserted. However, the latch enable signal LE may be high active. In such a case, a state that the latch enable signal LE is set to a high level is defined as a state that the latch enable signal LE is asserted.

Each of the output control blocks 13 has a function to provide a delay to the latch data signal Dᵢ only if the latch data signal Dᵢ rises from the low level to the high level. The latch data signal outputted from the output control block 13 is referred to as a latch data signal Dᵢ′ hereinafter. Specifically, if the latch enable signal LE is asserted to latch the drive data signal Si, and consequently the latch data signal Dᵢ rises from the low level to the high level, the output control block 13 waits for the rising of the latch data signal Dᵢ′ from the low level to the high level until the latch enable signal LE is negated. On the other hand, if the latch data signal Dᵢ falls from the high level to the low level, the output control block 13 immediately falls the latch data signal Dᵢ′ from the high level to the low level. That is, the rising of the latch data signal Dᵢ′ from the low level to the high level is performed in response to the negation of the latch enable signal LE, whereas the falling of the latch data signal Dᵢ′ from the high level to the low level is performed in response to the assertion of the latch enable signal LE (independently of the negation of the latch enable signal LE).

The pre-buffer 14 and the level shifter 15 correspond to a circuit section that generates control signals S_{UPi} and S_{DOWNi} for controlling each of the output buffers 16 in response to the latch data signal Di′. It should be noted that the control signal S_{UPi} is a signal for instructing the output buffer 16 connected to the data electrode wiring line Wᵢ to pull up the data electrode wiring line Wᵢ to the high level, and the control signal S_{DOWN i} is a signal for instructing the output buffer 16 connected to the data electrode wiring line Wᵢ to pull down the data electrode wiring line Wᵢ to the low level. The level shifter 15 has a role to increase a signal level of an output signal of the pre-buffer 14 to adapt a signal level of the control signal S_{UPi} to an input level of the output buffer 16.

Each of the output buffers 16 drives an output terminal OUTᵢ in response to the control signals S_{UPi} and S_{DOWNi}. The output terminal OUTᵢ is connected to the data electrode wiring line Wᵢ, and therefore each of the output buffers 16 plays a role to drive the data electrode wiring line Wᵢ.

The data driver 3 has the same configuration as that of the data driver 2. In the data driver 3, drive data signals S₂, S₄, . . . , S₂ₙ corresponding to the even-numbered data electrode wiring lines W₂, W₄, . . . , W₂ₙ are latched by latch blocks 12 to generate latch data signals D₂, D₄, . . . , D₂ₙ. Further, as necessary, the latch data signals D₂, D₄, . . . , D₂ₙ are delayed by the output control blocks 13 to generate latch data signals D₂′, D₄′, . . . , D₂ₙ′. In response to the generated latch data signals D₂′, D₄′, . . . , D₂ₙ′, the output terminals OUT₂, OUT₄, . . . , OUT₂ₙ (i.e., data electrode wiring lines W₂, W₄, . . . , W₂ₙ) are driven.

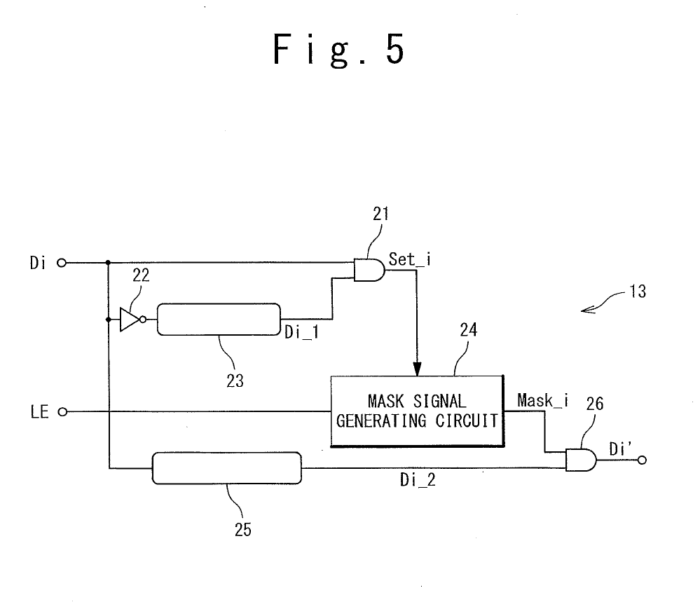

FIG. 5 is a circuit diagram illustrating an example of a configuration of the output control block 13 in the present embodiment. In the present embodiment, each of the output control blocks 13 is provided with an AND gate 21, an inverter 22, a delay element 23, a mask signal generating circuit 24, a delay element 25, and an AND gate 26.

The AND gate 21, the inverter 22, and the delay element 23 correspond to a circuit section for detecting the rising of the latch data signal Dᵢ, and generating a rise detection signal Set_i indicating that the latch data signal Dᵢ has risen. Specifically, the inverter 22 and the delay element 23 invert and further delay the latch data signal Dᵢ to output it. A signal outputted from the delay element 23 is hereinafter referred to as a signal Di_1. The AND gate 21 outputs a signal corresponding to a logical product of the latch data signal Dᵢ and the signal Di_1. The signal outputted from the AND gate 21 is the rise detection signal Set_i.

The mask signal generating circuit 24 generates a mask signal Mask_i from the latch enable signal LE and the detection signal Set_i. It should be noted that the mask signal Mask_i is a signal that suppresses (masks) the latch data signal Dᵢ′ from rising from the low level to the high level. Specifically, the mask signal generating circuit 24 asserts the mask signal Mask_i in response to assertion of the rise detection signal Set_i, or negates the mask signal Mask_i in response to negation of the latch enable signal LE. That is, a period during which the mask signal Mask_i is asserted is a period from when the rising of the latch data signal Di is detected to assert the rise detection signal Set_i to when the latch enable signal LE is negated. As will be described later, when the mask signal Mask_i is asserted, the latch data signal Dᵢ′ is held to the low level. In the present embodiment, the mask signal Mask_i is low active, and a state that the mask signal Mask_i is in the low level is equivalent to a state that the mask signal Mask_i is asserted.

The delay element 25 and the AND gate 26 correspond to a circuit section that delays the latch data signal Dᵢ, and outputs the latch data signal Dᵢ′ in response to the mask signal Mask_i. The delay element 25 delays the latch data signal Dᵢ to generate a signal Di_2. The AND gate 26 outputs a signal corresponding to a logical product of the mask signal Mask_i and the signal Di_2. The signal outputted from the AND gate 26 is the latch data signal Di′.

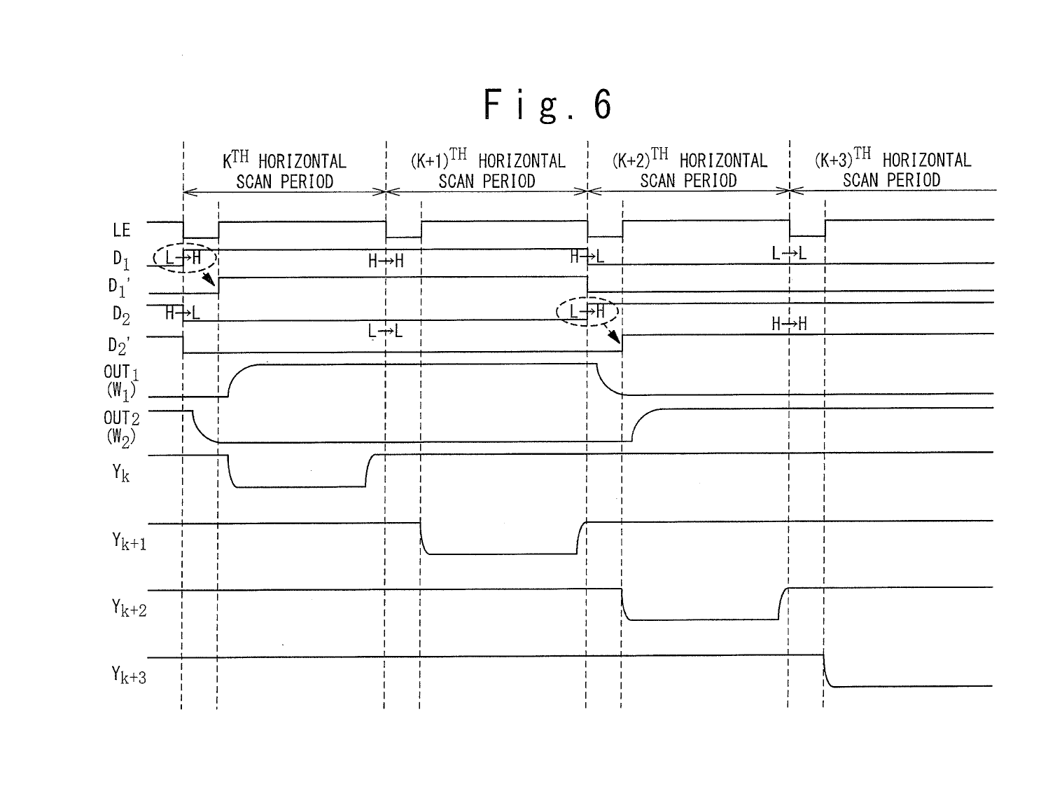

In the following, an operation of the data drivers 2 and 3 of the present embodiment will be described. First, referring to FIG. 6, an outline of the operation of the data drivers 2 and 3 will be described. In the following, there is described driving of the data electrode wiring lines W₁ and W₂ during horizontal scan periods (k^{th} to (k+3)^{th} horizontal scan periods) during which the scan electrode wiring lines Yₖ to Yₖ₊₃ are driven. It should be noted that the description will be given on the assumption that, during the k^{th} to (k+3)^{th} horizontal scan periods, the data electrode wiring lines W₁ and W2 are driven as follows:

During the k^{th} horizontal scan period, the data electrode wiring line W₁ is pulled up from the low level to the high level, and the data electrode wiring line W₂ is pulled down from the high level to the low level.

During the (k+1)^{th} horizontal scan period, the data electrode wiring line W₁ is held to the high level, and the data electrode wiring line W₂ is held to the low level.

During the (k+2)^{th} horizontal scan period, the data electrode wiring line W₁ is pulled down from the high level to the low level, and the data electrode wiring line W₂ is pulled up from the low level to the high level.

During the (k+3)^{th} horizontal scan period, the data electrode wiring line W₁ is held to the low level, and the data electrode wiring line W₂ is held to the high level.

When the latch enable signal LE is asserted (pulled down in FIG. 6) at the start time of the k^{th} horizontal scan period, the latch blocks 12 latch the drive data signals S₁ to S₂ₙ in the data drivers 2 and 3. As a result, the latch data signal D₁ outputted from the latch block 12 corresponding to the data electrode wiring line W₁ is pulled up from the low level to the high level, and the latch data signal D₂ is pulled down from the high level to the low level.

At this time, only the latch data signal D₁ pulled up from the low level to the high level is delayed, but the latch data signal D₂ is not delayed. That is, pulling-up of the latch data signal D₁′ corresponding to the data electrode wiring line W₁ is performed after pulling-down of the latch data signal D₂′ corresponding to the data electrode wiring line W₂. As a result, between the adjacent data electrode wiring lines W₁ and W₂, pulling-up of the data electrode wiring line W₁ is performed after pulling-down of the data electrode wiring line W₂. This is effective in reducing a power consumption.

Timing at which the latch data signal D₁′ is pulled up is determined depending on timing at which the latch enable signal LE is negated. As a result, timing at which the data electrode wiring line W₁ is pulled up is determined depending on the timing at which the latch enable signal LE is negated.

After driving of the data electrode wiring lines W₁ to W₂ₙ has been started, the scan electrode wiring line Yₖ is driven to drive a pixel corresponding to the scan electrode wiring line Yₖ.

Similarly, in the (k+2)^{th} horizontal scan period, only one of the latch data signals D₁ and D₂, which is to be pulled up, (the latch data signal D₂ during the (k+2)^{th} horizontal scan period) is delayed. When, the latch enable signal LE is asserted at the start time of the (k+2)^{th} horizontal scan period, the latch blocks 12 latch the drive data signals S₁ to S₂ₙ in the data drivers 2 and 3. As a result, the latch data signal D₁ outputted from the latch block 12 corresponding to the data electrode wiring line W₁ is pulled down from the high level to the low level, and the latch data signal D₂ is pulled up from the low level to the high level.

At this time, only the latch data signal D₂ pulled up from the low level to the high level is delayed, but the latch data signal D₁ is not delayed. That is, pulling-up of the latch data signal D₂′ corresponding to the data electrode wiring line W₂ is delayed later from pulling-down of the latch data signal D₁′ corresponding to the data electrode wiring line W₁. As a result, pulling-up of the data electrode wiring line W₂ is performed after pulling-down of the data electrode wiring line W₁. At this time, timing at which the data electrode wiring line W₂ is pulled up is determined depending on timing at which the latch enable signal LE is negated.

On the other hand, during the (k+1)^{th} or (k+3)^{th} horizontal scan period, the latch data signals D₁ and D₂ are at the same levels as those during the last horizontal scan period. Accordingly, the latch data signals D₁′ and D₂′ are unchanged, and voltage levels of the data electrode wiring lines W₁ and W₂ are also unchanged.

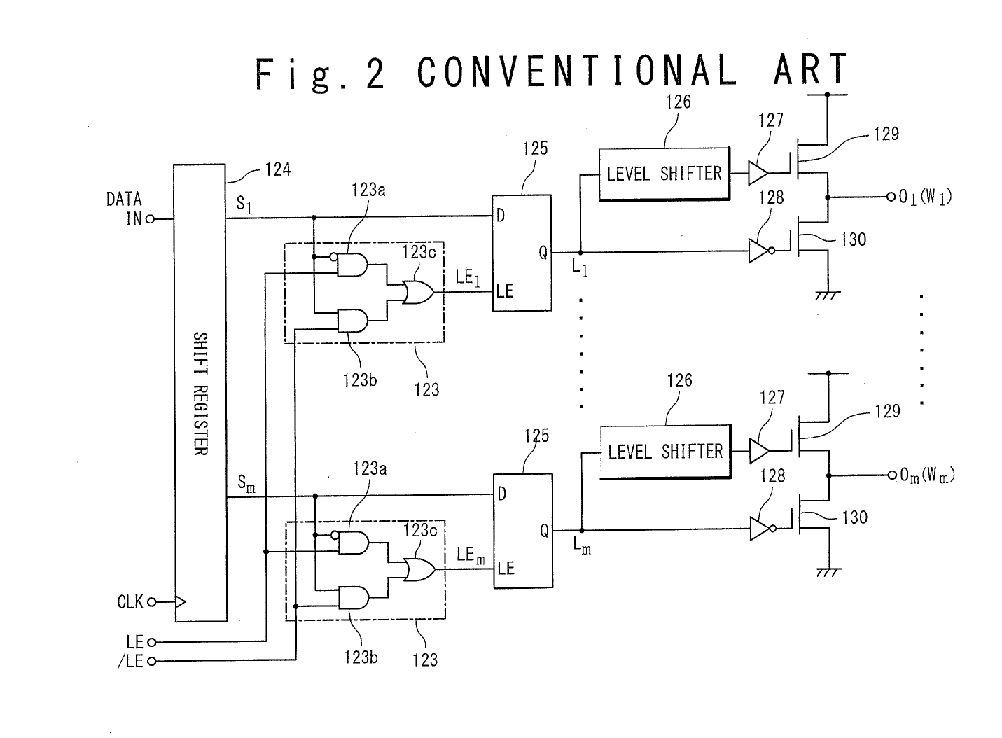

It should be noted that, in the present embodiment, operation of selectively delaying only pulling-up of a data electrode wiring line is performed in response to the single latch enable signal LE. In the technique described in FIG. 2, rising timing of a data electrode wiring line is determined in response to the rise latch enable signal LE, and falling timing of a data electrode wiring line is determined in response to the fall latch enable signal /LE. On the other hand, in the present embodiment, falling timing of a data electrode wiring line is determined depending on timing of assertion of the latch enable signal LE, whereas rising timing of the data electrode wiring line is determined depending on timing of negation of the latch enable signal LE. In the present embodiment, an operation to select and delay only the pulling-up of the data electrode wiring line is performed by using only the single latch enable signal LE. It is effective that the rising timing of the data electrode wiring line is determined depending on the timing of the negation of the latch enable signal LE, in order to make the rising timing of the data electrode wiring line externally controllable.

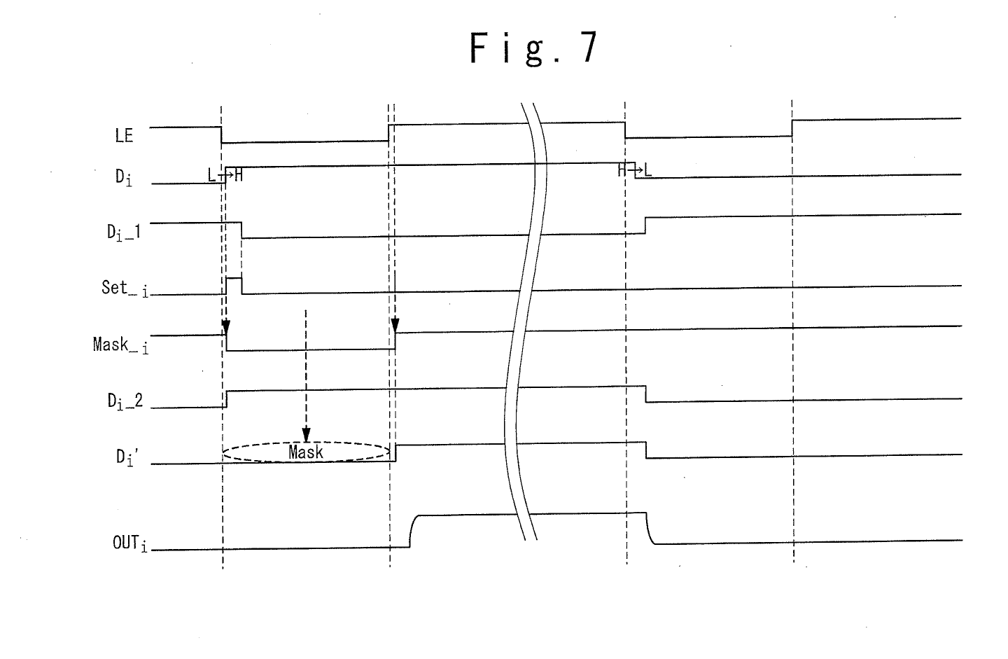

In the display apparatus 10 of the present embodiment, the operation of selecting and delaying only the pulling-up of the data electrode wiring line is achieved by use of a function of the output control block 13. FIG. 7 is a timing chart illustrating operation of the output control block 13.

There is first described the operation of the output control block 13 when the data electrode wiring line Wᵢ is pulled up from the low level to the high level. In the present embodiment, when the latch data signal Dᵢ is changed from the low level to the high level in response to the assertion of the latch enable signal LE, the data electrode wiring line Wᵢ is pulled up from the low level to the high level. The output control block 13 uses this to determine that the data electrode wiring line Wᵢ is pulled up if the latch data signal Dᵢ is pulled up, and asserts the rise detection signal Set_i. More specifically, in the present embodiment, by calculating the logical product of the signal Di_1 that is a signal obtained by inverting and further delaying the latch data signal Dᵢ and the latch data signal Dᵢ, the rise detection signal Set_i is generated. It will be obvious to one skilled in the art that the rise detection signal Set_i generated in this manner is asserted (pulled up in the present embodiment) depending on the pulling-up of the latch data signal Di.

When the rise detection signal Set_i is asserted, the mask signal Mask_i is asserted (in the present embodiment, the mask signal Mask_i is pulled down to the low level). This forbids the latch data signal Dᵢ′ from being pulled up. Then, when the latch enable signal LE is negated, the mask signal Mask_i is negated (in the present embodiment, pulled up to the high level), and the latch data signal Dᵢ′ is allowed to be pulled up. The latch data signal Dᵢ′ is generated as the logical product of the signal Di_2 obtained by delaying the latch data signal Dᵢ and the mask signal Mask_i. As a result, the latch data signal Dᵢ′ is a signal corresponding to the delayed latch data signal Dᵢ, and the timing at which the latch data signal Dᵢ′ is pulled up is determined based on the timing at which the latch enable signal LE is negated. As a result, the timing at which the data electrode wiring line Wᵢ is pulled up is also determined based on the timing at which the latch enable signal LE is negated.

On the other hand, in the case where the data electrode wiring line Wi is pulled down from the high level to the low level, the output control block 13 operates as follows. That is, even if the latch data signal Dᵢ is pulled down from the high level to the low level in response to the assertion of the latch enable signal LE, the rise detection signal Set_i is not asserted. As a result, the mask signal Mask_i remains negated. For this reason, the signal Di_2 is directly outputted as the latch data signal Dᵢ′. In this case, pulling-down of the latch data signal Dᵢ′ is performed after the pulling-down of the latch data signal Dᵢ by a delay time of the delay element 25. As a result, the timing at which the latch data signal Di′ is pulled down is determined depending on the timing at which the latch enable signal LE is asserted (independently of the timing at which the latch enable signal LE is negated). As a result, the timing at which the data electrode wiring line Wi is pulled down is also determined depending on the timing at which the latch enable signal LE is asserted (independently of the timing at which the latch enable signal LE is negated).

According to such an operation, the timing at which the latch data signal Di′ is pulled up can be delayed by a desired delay time from the timing at which the latch data signal Di′ is pulled down, on the basis of the timing at which the latch enable signal LE is negated. This enables the timing at which the data electrode wiring line is pulled up to be delayed by the desired delay time from the timing at which the data electrode wiring line is pulled down.

Control of the timing at which the latch enable signal LE is negated can be achieved by, for example, changing a setting of the controller 6 that generates the latch enable signal LE. The controller 6 controls the assertion timing and negation timing of the latch enable signal LE according to the setting. In this way, the pulling-up timing and pulling-down timing of the latch data signal Dᵢ′, i.e., the pulling-up timing and pulling-down timing of the data electrode wiring line can be controlled. At this time, by controlling the negation timing of the latch enable signal LE depending on a capacitance of each of the data electrode wiring lines W₁ to W₂ₙ in the PDP 1, a delay time from the pulling-down to the pulling-up of the data electrode wiring line can be set to an appropriate period.

In the above, the embodiment of the present invention is specifically described. However, the present invention is not limited to the above-described embodiment, but various modifications obvious to one skilled in the art can be made. For example, in the above-described embodiment, the circuit is configured on the assumption that when the latch enable signal LE is set to the low level, the latch enable signal LE is asserted. However, the circuit may be configured on the assumption that when the latch enable signal LE is set to the high level, the latch enable signal LE is asserted.

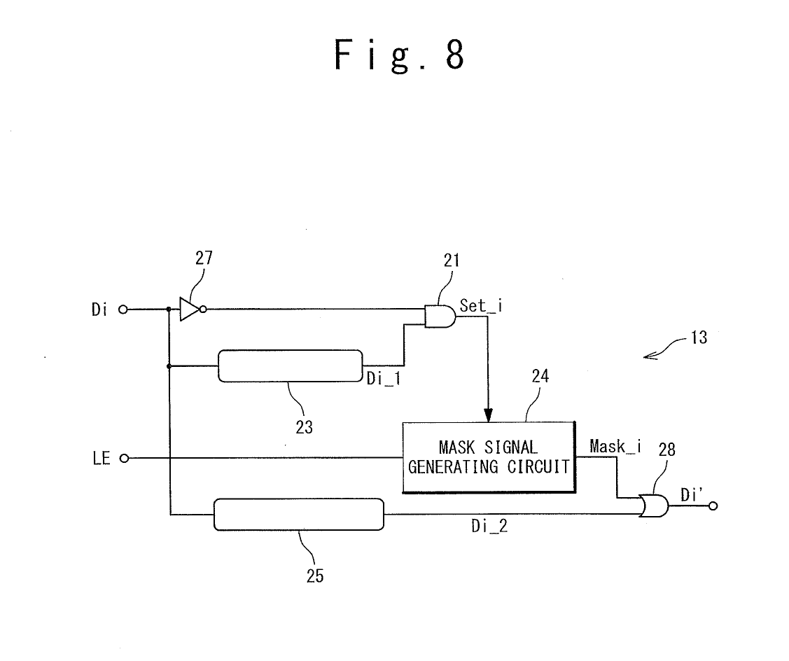

Also, in the above-described embodiment, the timing at which the data electrode wiring line is pulled up is delayed from the timing at which the data electrode wiring line is pulled down. However, the timing at which the data electrode wiring line is pulled down may be delayed later than the timing at which the data electrode wiring line is pulled up. In this case, the output control block 13 is configured to delay the pulling-down timing of the latch data signal Di′ from the pulling-up timing of the latch data signal Di′ by a desired delay time on the basis of the negation timing of the latch enable signal LE. FIG. 8 is a circuit diagram illustrating a configuration of the output control block 13 for this case.

The output control block 13 of FIG. 8 is provided with an AND gate 21, an inverter 27, a delay element 23, a mask signal generating circuit 24, a delay element 25, and an OR gate 28.

The AND gate 21, the inverter 27, and the delay element 23 correspond to a circuit section for detecting the falling of the latch data signal Di, and generates a fall detection signal Set_i indicating that the latch data signal Di has fallen. Specifically, a signal corresponding to a logical product of an inverted signal of the latch data signal Di generated by the inverter 27 and a signal Di_i outputted from the delay element 23 is outputted from the AND gate 21 as the fall detection signal Set_i. The mask signal generating circuit 24 generates a mask signal Mask_i from the latch enable signal LE and the fall detection signal Set_i. Specifically, the mask signal generating circuit 24 asserts the mask signal Mask_i in response to assertion of the rise detection signal Set_i, or negates the mask signal Mask_i in response to negation of the latch enable signal LE. That is, a period during which the mask signal Mask_i is asserted is a period from a time point when the rising of the latch data signal Dᵢ is detected to assert the rise detection signal Set_i to a time point when the latch enable signal LE is negated. In the circuit configuration of FIG. 8, the mask signal Mask_i is high active, and a state that the mask signal Mask_i is at the high level is equivalent to a state that the mask signal Mask_i is asserted.

The delay element 25 and the OR gate 28 correspond to a circuit section that delays the latch data signal Dᵢ, and generate a latch data signal Dᵢ′ in response to the mask signal Mask_i. The delay element 25 delays the latch data signal Dᵢ to generate a signal Di_2. The OR gate 28 outputs a signal corresponding to a logical summation of the mask signal Mask_i and the signal Di_2. The signal outputted from the OR gate 28 is the latch data signal Dᵢ′.

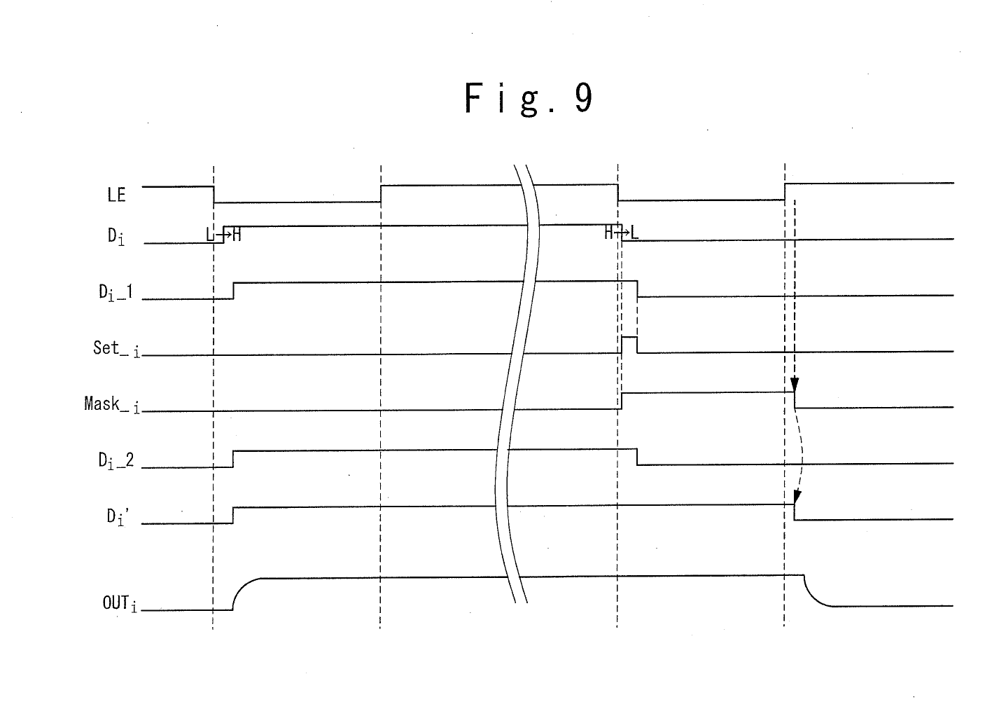

FIG. 9 shows timing charts illustrating an operation of the output control block 13 having the configuration in FIG. 8. The operation of the output control block 13 when the data electrode wiring line Wᵢ is pulled down from the high level to the low level will be described. The output control block 13 having the configuration in FIG. 8 determines that the data electrode wiring line Wᵢ is pulled down if the latch data signal Dᵢ is pulled down, and asserts the rise detection signal Set_i. More specifically, in the present embodiment, the fall detection signal Set_i is generated by calculating a logical product of the signal Di_1 obtained by delaying the latch data signal Dᵢ and the inverted signal of the latch data signal Dᵢ. It will be obvious to one skilled in the art that the fall detection signal Set_i generated in this manner is asserted (pulled up in the present embodiment) depending on the pulling-down of the latch data signal Dᵢ.

When the fall detection signal Set_i is asserted, the mask signal Mask_i is asserted (in the present embodiment, the mask signal Mask_i is pulled up to the high level). This forbids the latch data signal from being pulled down. Then, when the latch enable signal LE is negated, the mask signal Mask_i is negated (in the present embodiment, pulled down to the low level), and the latch data signal Dᵢ′ is allowed to be pulled down. The latch data signal Dᵢ′ is generated as the logical summation of the signal Di_2 obtained by delaying the latch data signal Dᵢ and the mask signal Mask_i. As a result, the latch data signal Dᵢ′ is a signal corresponding to the delayed latch data signal Dᵢ, and timing at which the latch data signal Dᵢ′ is pulled down is determined based on timing at which the latch enable signal LE is negated. As a result, timing at which the data electrode wiring line Wᵢ is pulled down is also determined based on the timing at which the latch enable signal LE is negated.

On the other hand, when the data electrode wiring line Wᵢ is pulled up from the low level to the high level, the output control block 13 operates as follows. That is, even if the latch data signal Dᵢ is pulled up from the low level to the high level in response to the assertion of the latch enable signal LE, the rise detection signal Set_i is not asserted. As a result, the mask signal Mask_i remains negated. For this reason, the signal Di_2 is directly outputted as the latch data signal Dᵢ′. In this case, pulling-up of the latch data signal Dᵢ′ is delayed from the pulling-up of the latch data signal Dᵢ by a delay time of the delay element 25. As a result, timing at which the latch data signal Dᵢ′ is pulled up is determined depending on timing at which the latch enable signal LE is asserted (independently of the timing at which the latch enable signal LE is negated). As a result, timing at which the data electrode wiring line Wᵢ is pulled up is also determined depending on the timing at which the latch enable signal LE is asserted (independently of the timing at which the latch enable signal LE is negated).

According to such an operation, the timing at which some latch data signal Dᵢ′ is pulled down can be delayed by a desired delay time from the timing at which the latch data signal Dᵢ′ is pulled up on the basis of the timing at which the latch enable signal LE is negated. This enables the timing at which the data electrode wiring line is pulled down to be delayed by the desired delay time from the timing at which the data electrode wiring line is pulled up.

Although the present invention has been described above in connection with several embodiments thereof, it would be apparent to those skilled in the art that those embodiments are provided solely for illustrating the present invention, and should not be relied upon to construe the appended claims in a limiting sense.

What is claimed is:

1. A display panel driver comprising:
a latch block configured to latch a drive data signal corresponding to an image in response to assertion of a latch enable signal supplied externally and output the latched drive data signal as a first latch data signal;
an output control block configured to delay said first latch data signal in response to said latch enable signal to generate a second latch data signal; and
a drive circuit section configured to drive a wiring provided in a display panel in response to said second latch data signal,
wherein one of rising timing and falling timing of said second latch data signal outputted from said output control block is delayed from the other timing,
wherein said one timing is determined in response to negation of said latch enable signal, and
wherein the other timing is determined regardless of the negation of said latch enable signal.

2. The display panel driver according to claim 1, wherein said output control block is configured to detect rising of said first latch data signal, and
wherein said output control block delays the rising timing of said second latch data signal until said latch enable signal is negated, when the rising of said first latch data signal is detected.

3. A display apparatus comprising:
a display panel;
a display panel driver configured to drive a wiring provided in said display panel; and
a controller configured to supply a latch enable signal and a drive data signal corresponding to an image,
wherein said display panel driver comprises:
a latch block configured to latch said drive data signal in response to assertion of a latch enable signal and output the latched drive data signal as a first latch data signal;
an output control block configured to delay said first latch data signal in response to said latch enable signal to generate a second latch data signal; and
a drive circuit section configured to drive said wiring provided in said display panel in response to said second latch data signal,
wherein one of rising timing and falling timing of said second latch data signal outputted from said output control block is delayed from the other timing,
wherein said one timing is determined in response to negation of said latch enable signal, and
wherein the other timing is determined regardless of the negation of said latch enable signal.

4. The display apparatus according to claim 3, wherein said output control block is configured to detect rising of said first latch data signal, and
wherein said output control block delays the rising timing of said second latch data signal until said latch enable signal is negated, when the rising of said first latch data signal is detected.

5. The display apparatus according to claim 3, wherein said controller controls timing that said latch enable signal is negated.

6. A method of driving a display panel, comprising:
supplying a latch enable signal and a drive data signal corresponding to an image to a display panel driver;
latching said drive data signal in response to assertion of said latch enable signal;
outputting the latched drive data signal as a first latch data signal;
delaying said first latch data signal in response to said latch enable signal to generate a second latch data signal; and
driving a wiring provided in a display panel in response to said second latch data signal,
wherein one of rising timing and falling timing of said second latch data signal outputted from said output control block is delayed from the other timing,
wherein said one timing is determined in response to negation of said latch enable signal, and
wherein the other timing is determined regardless of the negation of said latch enable signal.

7. The method according to claim 6, further comprising:
controlling timing that said latch enable signal is negated.
